(19) United States
(12) Patent Application Publication
(10) Pub. No.: US 2016/0248641 A1
(43) Pub. Date: Aug. 25, 2016

(54) CONFIGURATION OF A TRIAL SERVICE

(71) Applicant: Cox Communications, Inc., Atlanta, GA (US)

(72) Inventors: Lalit T. Bhatia, Atlanta, GA (US); Joshua Shane Hutchins, Atlanta, GA (US); Alejandro M. Slinin, Atlanta, GA (US); Jamie Allison Kole, Atlanta, GA (US)

(21) Appl. No.: 14/630,221

(22) Filed: Feb. 24, 2015

(51) Int. Cl. H04L 12/24; G06Q 30/02

(52) U.S. Cl. CPC H04L 41/5064; H04L 41/5054; G06Q 30/0235

(57) ABSTRACT

Embodiments of the disclosure relate to configuration of a service in trial mode for a certain trial period. The service consumed in trial mode can be provided by a multiple service operator, and can be accessed via customer premises equipment (CPE) within a unit within a multiple dwelling unit and/or via user equipment outside the unit. A subscription to the service or other services can be implemented in response to expiration of the trial period. Trial of the service does not rely financial information associated with a consumer nor does the trial rely on a billing account for the service.

### BACKGROUND

Initiating services provided by a multiple service operator (MSO) when a temporary resident of a dwelling, such as a tenant in an apartment home or a resident in a nursing home, generally entails coordination between an agent of the service provider and the tenant. The configuration of a service is time consuming for the tenant, and it causes the utilization of various resources of the MSO. For example, installation of equipment and configuration thereof can demand scheduling a field visit from a technician, transportation of the equipment, and the like. Delays or re-scheduling of field visits can be occasionally unavoidable, with ensuing detriment to the perceived quality of service from the prospective consumer.

### BRIEF DESCRIPTION OF THE DRAWINGS

The accompanying drawings are an integral part of the disclosure and are incorporated into the subject specification, and illustrate example embodiments of the disclosure. The drawings, in conjunction with the summary, description, and claims serve to explain various principles, features, and/or aspects of the disclosure.

FIG. 1 illustrates an example operational environment for configuration of a trial service in accordance with one or more embodiments of the disclosure.

FIG. 2 presents an example computing platform for configuration of a trial service in accordance with one or more embodiments of the disclosure.

FIG. 3A presents an example of a user interface for configuration of a trial service in accordance with one or more embodiments of the disclosure.

FIG. 3B presents another example of a user interface for configuration of a trial service in accordance with one or more embodiments of the disclosure.

FIG. 4 presents an example of an information exchange for configuration of a trial service in accordance with one or more embodiments of the disclosure.

FIG. 5 illustrates an example computing environment for configuration of a trial service in accordance with one or more embodiments of the disclosure.

FIGS. 6-7 present examples of methods for configuring a trial service in accordance with one or more embodiments of the disclosure.

### DETAILED DESCRIPTION

The disclosure recognizes and addresses, in at least certain embodiments, the issue of service configuration in multi-dwelling units (MDUs) and other types of time-shared dwellings in which a consumer can reside for a predetermined period. Embodiments of the disclosure provide systems, apparatuses, devices, methods, and computer-program products for providing video, data, and/or other services from a multiple services operator (MSO) during a trial period with an option to subscribe to the service in a non-trial mode. While embodiments of the disclosure are illustrated with reference to MDUs, such as apartment complexes, student housing, rental condominiums, rental townhomes, retirement homes, and the like, the disclosure is not limited in this respect and other dwellings or living spaces can be contemplated.

As described in greater detail below, in certain embodiments, customer premises equipment (CPE) can be installed (permanently or otherwise) in an apartment or another type of living space within an MDU. The CPE can include a modem and a wireless gateway, which can be integrated into a single device. In response to an initial attempt or request from user equipment (e.g., a laptop computer or a mobile device) to access broadband service via the CPE, an end-user can be prompted to accept the broadband service on a trial basis (which may be referred to as a trial mode). To such an end, the user equipment (UE) can access a captive portal (or “walled garden” webpage) conveying the availability of the broadband service and/or other types of service on a trial basis for a trial period (e.g., seven days, 10 days, 15 days, 30 days, or the like). In one scenario, the UE can receive input information conveying acceptance of the service trial. In response, the UE can prompt an end-user to enter certain identification information, such as name of the MDU community, end-user name (e.g., first and last name), apartment or unit number, or the like. In addition or in the alternative, the UE can prompt the end-user to provide selection information indicative of additional services available to the UE or other user devices of the end-user. At least a portion of the information received at the UE can be transmitted, via the CPE, for example, to a service configuration platform that can permit provisioning the CPE for broadband service and any of the other selected services. After the CPE is provisioned, the service trial can commence.

As the broadband service and/or other services are consumed, the service configuration platform can provide reminder information conveying that the service(s) are being provided in trial mode and that the end-user can subscribe to one or more of the service(s). In response to a UE providing opt-in information for subscription to a service currently in trial mode, the UE can be directed to an e-commerce interface and flow that can permit providing additional qualifying information to subscribe to the service. After the subscription is complete, the service configuration platform in accordance with the disclosure can provision the CPE in an active state and can provision a service account for the CPE in an account management platform.

In scenarios in which a service trial is not accepted and/or the trial elapses without a subscription to the broadband service, the service configuration platform in accordance with the disclosure can place the CPE in a “walled garden” state by configuring provisioning parameters at the back-end, for example, so that the CPE remains ready for trial upon or after another tenant moves in and is prompted to initiate a service trial of broadband service.

It can be appreciated that, in certain embodiments, the present disclosure removes or otherwise mitigates interaction—e.g., discussions, scheduling of field visits, or other types of direction—between customer representatives of an MSO and a resident in an MDU when configuring services (data, cable television, telephone, cloud storage, and the like) in trial mode. In addition or in other embodiments, in contrast to conventional technologies for establishing a trial service, the present disclosure permits providing access to a service by CPE or UE in trial mode, without relying on an account management platform (e.g., a billing component) and generating an account for such a service. Access to the service in trial mode also does not demand nor does rely on financial information from a consumer that utilizes the service. Further or in yet other embodiments, the present disclosure provides flexibility in the customization of trial services for user equipment of the resident.

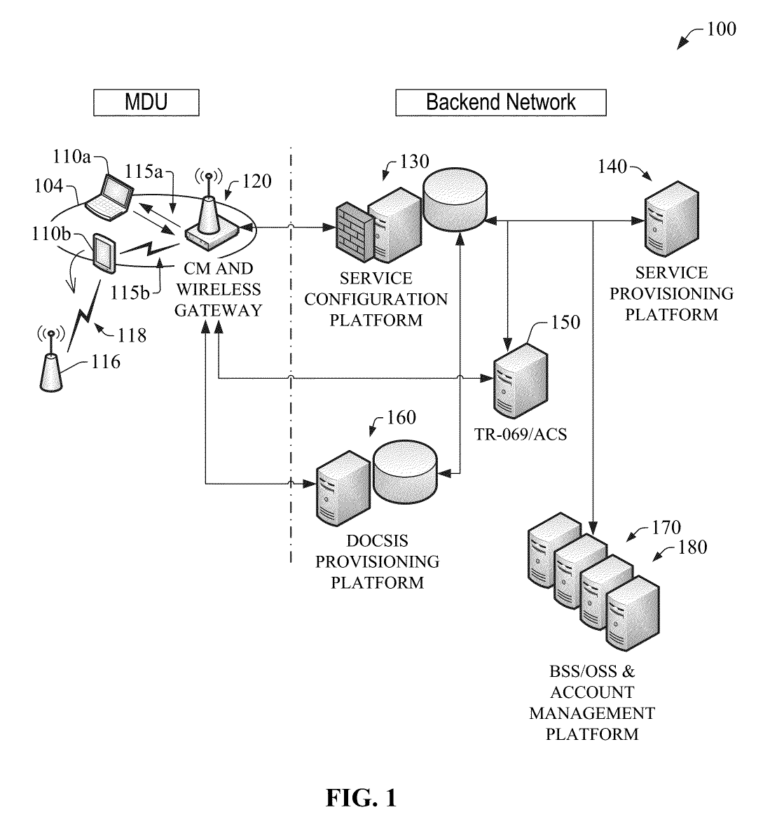

With reference to the drawings, FIG. 1 illustrates an example of an operational environment 100 for configuration of services in an MDU in accordance with one or more embodiments of the disclosure. The services can be initially configured on a trial basis and a subscription for the service can be implemented after a certain trial period. A living space 104 of the MDU, such as an apartment or a suite, can be fitted with CPE 120 that can integrate a cable modem (CM) and a wireless gateway. The living space 104 also may be referred to as a unit 104. User equipment (UE) 110a can be functionally coupled to the CPE 120 via links 115a (wireless or otherwise). Upon or after an attempt to access a uniform resource locator (URL) via the UE 110a or other user equipment coupled to the CPE 120, a request for the URL can be redirected to the service configuration platform 130. Accordingly, the service configuration platform 130 can operate as a proxy for the request. It should be appreciated that, in one example, a component of an access network (e.g., a local area network (LAN), a metropolitan area network (MAN), and/or a wide area network (WAN); not depicted) can redirect such a request to the service configuration platform 130. In certain embodiments, the service configuration platform 130 can query a data over cable service interface specification (DOCSIS) provisioning platform 160 in order to determine an operational state of the CPE 120. The DOCSIS provisioning platform 160 can be queried, for example, in response to the request for the URL or to other events. In addition or in another example, the DOCSIS provisioning platform 160 can be queried at certain times (e.g., according to a schedule or periodically). In other embodiments, in response to a certain event or at a specific time, for example, the DOCSIS provisioning platform 160 can push or otherwise send information indicative of the operational state of the CPE 120. The operational state can be an “online” state or a “walled garden” state (which also may be referred to as a “captive” state). The online state can correspond to a state in which the CPE 120 is provisioned, and the captive state can correspond to a state in which the CPE 120 is non-provisioned or otherwise unavailable to provide broadband service or another type of service (e.g., telephone service, wireless service, video-on-demand, or the like). It should be appreciated that, in certain implementations, CPE available in a living space (e.g., the unit 104, such as an apartment unit, a suite in a nursing home, or the like) can be configured in the captive state upon initial installation in the living space. In one of such implementations, the DOCSIS provisioning platform 160 can push or otherwise send information indicative of the captive state of the CPE. In certain examples, the DOCSIS provisioning platform 160 can be embodied in or can include a server that operates according to DOCSIS.

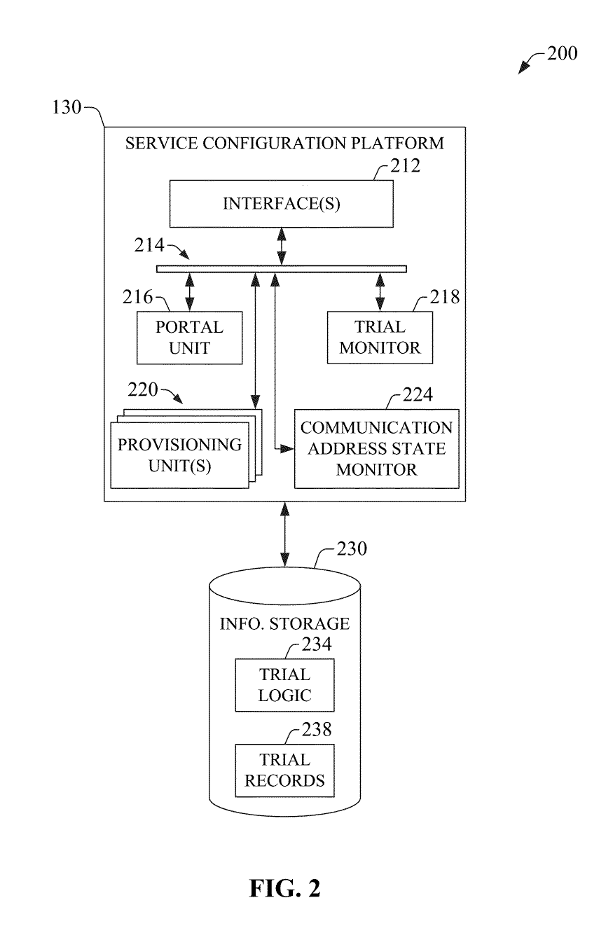

In addition to maintaining information indicative or otherwise representative of the operational state of the CPE 120, the DOCSIS provisioning platform 160 also can include a mapping of a MAC address of the CPE 120 and an IP address. More generally, the DOCSIS provisioning platform 160 can include a mapping between a first communication address and a second communication address of the CPE 120. In certain embodiments, e.g., embodiment 200 shown in FIG. 2, the service configuration platform 130 can include one or more interfaces 212, which can embody or include firewall(s), application programming interface(s), software framework(s), and/or input/output interface(s). One interface of the interface(s) 212 can receive the redirected request and another interface of the interface(s) 212 can transmit a query for the operational state of the CPE 120. The interface that transmits such a query can receive state information indicative or otherwise representative of the operational state of the CPE 120.

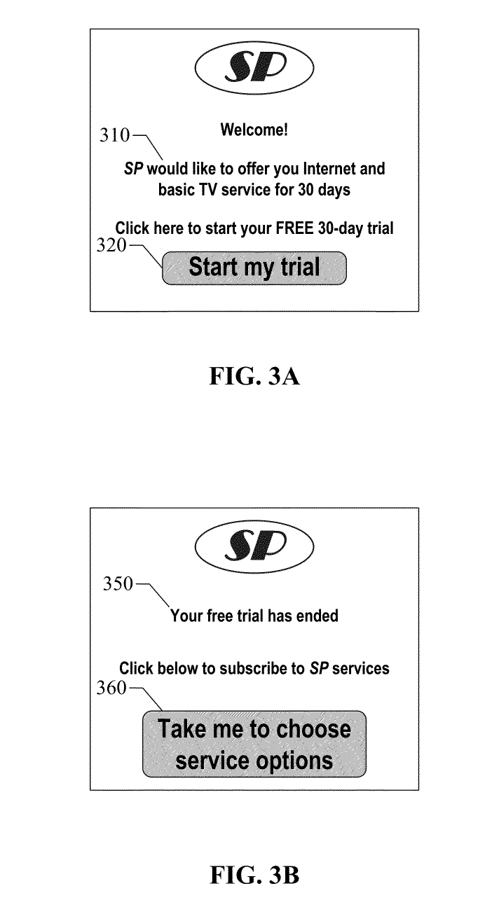

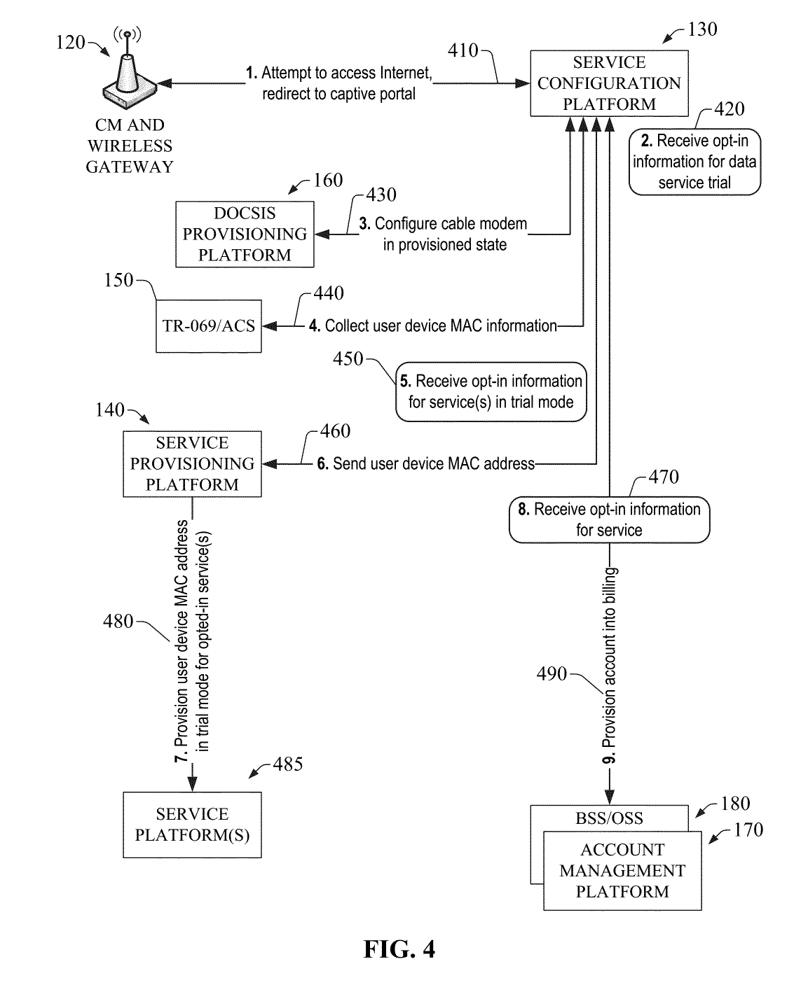

In response to determining that the CPE 120 is in a captive state, the service configuration platform 130 can supply prompt information (e.g., data and/or metadata) to the UE 110a via the CPE 120. To that end, in certain embodiments, such as embodiment 200 shown in FIG. 2, a portal unit 216 can receive state information and can determine that the CPE 120 is in the captive state. In addition or in other embodiments, the portal unit 216 can supply (e.g., generate and transmit) the prompt information. In one aspect, the prompt information can be processed (e.g., rendered and/or displayed) at the UE 110 and can convey an offer for broadband service or other types of services for a trial period, and/or a prompt to accept the broadband service or the other service. More specifically, in one example, processing at least a portion of the prompt information can cause the UE 110a to present a user interface (e.g., a webpage in a web browser) conveying indicia, selectable and otherwise, indicative of such an offer and/or such a prompt. FIG. 3A presents an example of such a user interface in accordance with one or more aspects of the disclosure. The exemplified user interface includes indicia 310 conveying an offer for Internet service and basic television (TV) service in trial mode for 30 days. In addition, selectable indicia 320 prompts an end-user to accept the offer. As described herein, the offer can be provided by a service provider (generically represented with the acronym “SP” in FIGS. 3A-3B).

With further reference to FIG. 1, the UE 110a can supply opt-in information indicative of acceptance of broadband service and/or other types of services in trial mode. For instance, the selectable indicia 320 can be selected and information (e.g., data and/or signaling) can be sent to the service configuration platform 130 via the CPE 120. In response to the received opt-in information, the service configuration platform 130 can supply prompt information requesting certain identification information, such as name of the MDU community associated with the CPE 120, end-user name (e.g., first and last name), apartment or unit number, or the like. In certain embodiments, the portal unit 216 shown in FIG. 2, can supply such prompt information. The UE 110a can process such prompt information and, in response, can render a user interface including selectable or otherwise actionable indicia (e.g., a fillable HTML form) that can permit providing at least a portion of the identification information. Input information embodying the requested identification information can be supplied by the UE 110a to the service configuration platform 130 via the CPE 120. In response to the opt-in information and/or the identification information, the service configuration platform 130 can configure the CPE 120 to provide the accepted service in trial mode. To at least that end, in certain embodiments, the service configuration platform 130 can direct or otherwise cause the DOCSIS provisioning platform 160 to provision the CPE 120, thus switching the CPE 120 to an online state. In addition or in other embodiments, the service configuration platform 130 also can initiate a trial timer or otherwise implement a trial rule including a time trigger for initiation of the service in trial mode. Moreover or in yet other embodiments, the service configuration platform 130 can generate a trial record for the CPE 120, where the trial record can include a starting date and identification information associated with the CPE 120. In certain embodiments, such as embodiment 200 shown in FIG. 2, the service configuration platform 130 can include one or more provisioning units 220, where one of such provisioning unit(s) 220 can direct or otherwise cause (e.g., transmit a directive or instruction to) the DOCSIS provisioning platform 160 to provision the CPE 120 in trial mode. One of the interface(s) 212 can be functionally coupled to the DOCSIS provisioning platform 160 and can send or otherwise communicate a directive to configure the CPE 120 in a provisioned state. In addition or in other embodiments, the trial monitor 218 can generate a trial record for the CPE 120. Trial records generated at the service configuration platform 130 can be retained at one or more memory elements 238 (referred to as trial records 238) within the information storage 230.

As illustrated, the service configuration platform 130 can include a bus architecture 214 (also termed bus 214) that can functionally couple two or more of the functional elements of the service configuration platform 130. In certain embodiments, the bus 214 can include at least one of a system bus, a memory bus, an address bus, a message bus, or reference link(s) and related functional elements, and can permit exchange of information (data, metadata, and/or signaling) between the interface(s) 212, the portal unit 216, the trial monitor 218, the provisioning unit(s) 220, the communication address state monitor 224, and/or the information storage 230, or two or more respective functional elements therein. In certain scenarios, the bus 214 in conjunction with one or more of the interface(s) 212 can permit such exchange of information.

The services that can be provided in trial mode also include, as described herein, TV service, wireless connectivity, media-on-demand, time-shifted media, cloud storage, email, combinations thereof, and the like. With further reference to FIG. 1, one or more of such services can be provided to user equipment that is coupled (wirelessly or otherwise) to the CPE 120 or to another access point or gateway outside the unit 104. Therefore, upon or after provisioning the CPE 120 in trial mode, the service configuration platform 130 can access information indicative or otherwise representative of a communication address of a UE in the living space containing the CPE 120. It should be appreciated that a service consumed in trial mode by such UE need not be provisioned or otherwise provided via the CPE 120 or other CPE (e.g., a set-top box) within the unit 104. In one example, a UE 110b can be associated with the unit 104 and, in certain scenarios, the UE 110b can be functionally coupled to the CPE 120 via links 115b (wireless or wireline, for example). In addition, the UE 110b can consume the service wirelessly via an access point (AP) 116 according to a specific radio technology protocol. As illustrated, the AP 116 can be external to the unit 104, e.g., the AP 116 can be deployed into a common living space within an MDU complex that includes the unit 104. The AP 116 and the UE 110b can be functionally coupled via links 118 (wireless links, for example). In response to receiving opt-in information for one of such services, in one embodiment, the service configuration platform 130 can supply (e.g., transmit or otherwise send) the communication address to a service provisioning platform 140 that can provision it for the opted-in service. More specifically, as an illustration, the service configuration platform 130 can rely on an auto-configuration server (ACS) 150 that can operate according to CPE WAN Management Protocol (CWMP) as specified in Technical Report (TR)-069. As such, in one example, the service configuration platform 130 can query the ACS 150 and, in response, can receive the communication address of the UE. It should be appreciated that, in certain aspects, the ACS 150 can collect or otherwise access the communication address of user equipment functionally coupled to the CPE 120. In addition or in other aspects, the ACS 150 can manage password(s) or other type of credentials associated with the service set identification (SSID) that may be established by the wireless gateway associated with the CPE 120.

The service configuration platform 130 can supply (e.g., transmit or otherwise send, or generate and transmit) the communication address to a service provisioning platform 140, which can configure the communication address in trial mode for the opted-in service (e.g., Wi-Fi wireless service or media-on-demand). In certain embodiments, the communication address can be embodied in a MAC address and the UE can communicate wirelessly with the CPE 120 according to Wi-Fi protocol. It should be appreciated that other types of communication addresses and radio technology protocols for communication between the CPE 120 and the UE are contemplated in the present disclosure. In one example, one of the provisioning unit(s) 220 that can be included in the service configuration platform 130 can supply the communication address to the service provisioning platform 140, via one of the interface(s) 212, for example. In another example, one of the provisioning unit(s) 220 can provision the equipment having the communication address, without reliance on the service provisioning platform 140.

The service configuration platform 130 can monitor the implementation of services in trial mode. To that end, upon or after provisioning the CPE 120 in trial mode, the service configuration platform 130 can implement one or more trial rules—e.g., validate the trial state of the communication address of the CPE 120 or another device included in the trial service; trigger termination of a service in trial mode after a trial period has elapsed; supply reminder information that the service is being provided in trial mode; and/or supply prompt information to subscribe to the service being consumed in trial mode upon or after the trial period elapses. As such, it should be appreciated that, in one aspect, implementation of the trial rule(s) can trigger directives that can cause the DOCSIS provisioning platform 160 to de-provision the CPE 120 and/or that can cause the service provisioning platform 140 to de-provision one or more services, such as television service, wireless connectivity, media-on-demand, and the like. Similarly, in another aspect, implementation of a trial rule can cause the service configuration platform 130 to transmit the prompt information to subscribe to service(s) after a trial period has ended. In certain embodiments, e.g., embodiment 200 shown in FIG. 2, the trial monitor 218 can implement (e.g., execute) logic including the one or more trial rules. Such logic can be referred to as trial logic and can be retained in one or more memory elements 234 (referred to as trial logic 234) within one or more memory devices 230 (collectively referred to as information storage 230). In addition or in other embodiments, a communication-address state monitor 224 can maintain a record or correlation between a communication address of a device or equipment (e.g., a MAC address or an IP address) and a trial state conveying whether the device or equipment can consume a service in trial mode.

As an illustration, upon or after the trial period ends, the service configuration platform 130 can direct the DOCSIS provisioning platform 160 to switch the operational state of the CPE 120 from the online state to the captive state. In addition, the service configuration platform 130 can transmit the prompt information for subscription to the service being consumed in trial mode. At least a portion of such information can be received by user equipment (e.g., UE 110a or UE 110b), via the CPE 120 or another access point and/or gateway. The user equipment can process the received information and, thus, can present it to an end-user. In one example, the prompt information can be presented as a user interface. In one example, such as embodiment 200 shown in FIG. 2, the trial monitor 218 can determine that the trial period has ended, and the portal unit 216 can supply (e.g., generate and transmit) the prompt information. Further, as illustrated in FIG. 3B, the user interface can include indicia 350 indicative of termination of the trial, and selectable indicia 360 indicative of a prompt to select subscription options for a service. In response to selection or otherwise actuation of the selectable indicia 360, the UE that presents the user interface can sent opt-in information to the service configuration platform 130. The opt-in information can cause (e.g., direct or otherwise instruct) the service configuration platform 130 to supply information indicative of options for subscription to one or more services—e.g., subscribe to a data service with a certain quality of service, such as certain guaranteed download rates; subscribe to a television service having a specific channel line-up, such as a basic package, a premium package, a service package including pay-per-view choices, a service package including end-user customized selection of channels, or the like; subscribe to media-on-demand service; subscribe to a second-screen service (e.g., television service provided via a tablet computer); combinations thereof; or the like. The user equipment (e.g., UE 110a or UE 110b) can receive the subscription information and can process it to present it to an end-user. It should be appreciated that, in certain embodiments, a set-top box can receive the subscription information and can process at least a portion thereof for transmission to a terminal display or other device. The terminal display or the other device can present the subscription information to an end-user. The subscription information can be presented as a subscription interface (which can be part of an e-commerce flow). The UE or CPE can receive opt-in information indicative or otherwise representative of services to be subscribed to, and can transmit at least a portion of the opt-in information to the service configuration platform 130.

With further reference to FIG. 1, the service configuration platform 130 can receive opt-in information indicative or otherwise representative of a service to subscribe after the consumption of the service in trial mode has ended. In response to receiving at least a portion of such information, the service configuration platform 130 can provision an account for the service. To that end, in one example, the service configuration platform 130 can direct or otherwise cause an account management platform 170 to generate the account and assess charges for consumption of the service. In addition, the service configuration platform 130 can direct or otherwise cause a component of business support systems/operational support systems (BSS/OSS) 180 to configure entitlements (authentication entitlements, authorization entitlements, and so forth) for the service being subscribed to. The service so provisioned can be consumed by a subscriber associated with the CPE 120. In certain embodiments, e.g., embodiment 200 shown in FIG. 2, a provisioning unit of the provisioning unit(s) 220 can provision the account for the service and can direct or otherwise cause (e.g., transmit a directive or instruction to) the BSS/OSS 180 to configure a group of entitlements for a consumer or equipment (e.g., CPE 120, UE 110a, and/or UE 110b) associated therewith.

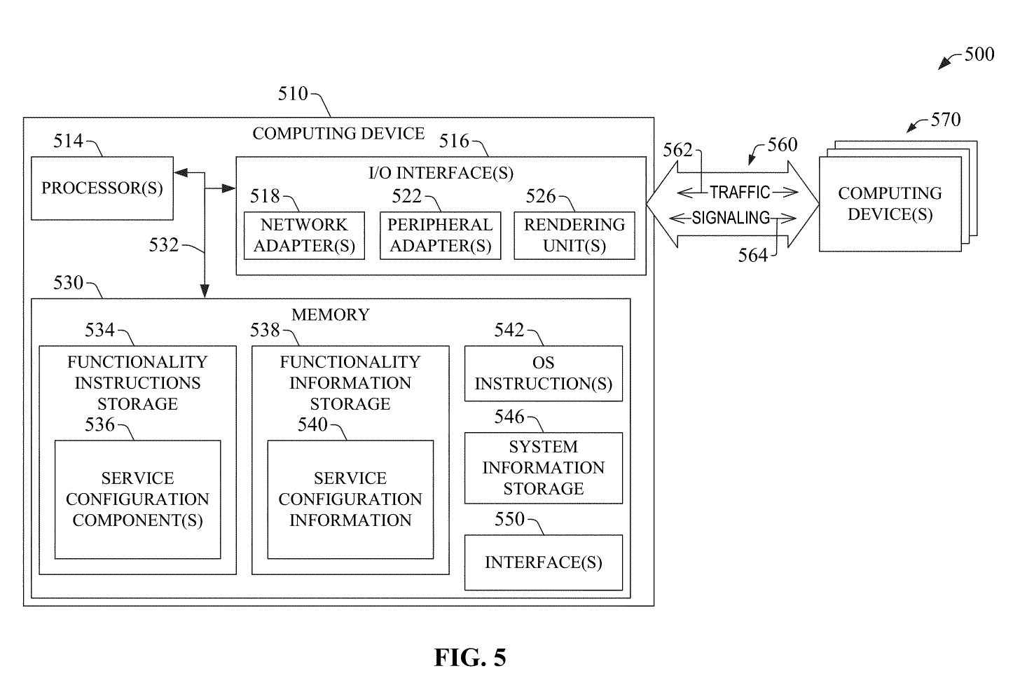

As it can be readily appreciated, various integrations within the operational environment 100 permit the configuration of a service in trial mode. As a further illustration, FIG. 4 presents an example of an information exchange for configuration of a trial service in accordance with one or more embodiments of the disclosure. The information can be communicated in accordance with various communication protocols, such as HTTP, simple network management protocol (SNMP), CWMP, a combination thereof, or the like. At 410, the CPE 120 transmits a request for a URL or other type of internet access (e.g., a request to access a remote server, such as a VPN server). The CPE 120 can be non-provisioned and, thus, the request can be redirected to the service configuration platform 130. As described herein, the service configuration platform 130 can determine that the CPE 120 is not provisioned, and can provide a captive interface to the CPE 120. A UE functionally coupled to the CPE 120 can receive information representative of the captive interface. As described herein, the captive interface can prompt an end-user to accept a service on a trial basis. In response to providing the captive interface, at 420, the service configuration platform 130 can receive opt-in information for a data service in trial mode. At 430, the service configuration platform 130 can transmit provisioning information that configures the CPE 120 (or a cable modem therein, for example) in a provisioned state. The provisioning information can be received at the DOCSIS provisioning platform 160, which can retain a record or otherwise maintain the provisioning state of the CPE 120.

Upon or after provisioning the CPE 120, at 440, the service configuration platform 130 can exchange information with the ACS 150 in order to collect or otherwise access information indicative of communication address(es) (e.g., MAC address(es)) of respective user equipment associated with the CPE 120. In addition, at 450, the service configuration platform 130 can receive opt-in information (e.g., selection information) indicative or otherwise representative of a service that may be consumed via a user equipment (e.g., UE 110b) that is not functionally coupled to the CPE 120. For instance, the service can include Wi-Fi connectivity that may be consumed via an access point (e.g., AP 116) external to the unit including the CPE 120. In response to receiving the selection information, at 460, the service configuration platform 130 can send a communication address of a user equipment (e.g., UE 110b) to the service provisioning platform 140, where the user equipment may be selected or otherwise configured to consume a service (e.g., wireless connectivity) in trial mode. At 480, the service provisioning platform 140 can provision the communication address (e.g., a MAC address) with at least one of the one or more service platform(s) 485. In certain embodiments, the service configuration platform 130 can provision the communication address, without reliance on the service provisioning platform 140.

As described herein, the service configuration platform 130 can establish the termination of a trial and, in response, can provide prompt information to the CPE 120 and/or a UE associated therewith for subscription to a service for which the trial has ended. At 470, the service configuration platform 130 can receive opt-information, including subscription information, for such a service and/or other type of services. In response, at 490, the service configuration platform 130 can provision an account for the service with the account management platform 170 and/or the BSS/OSS 180 in accordance with aspects described herein.

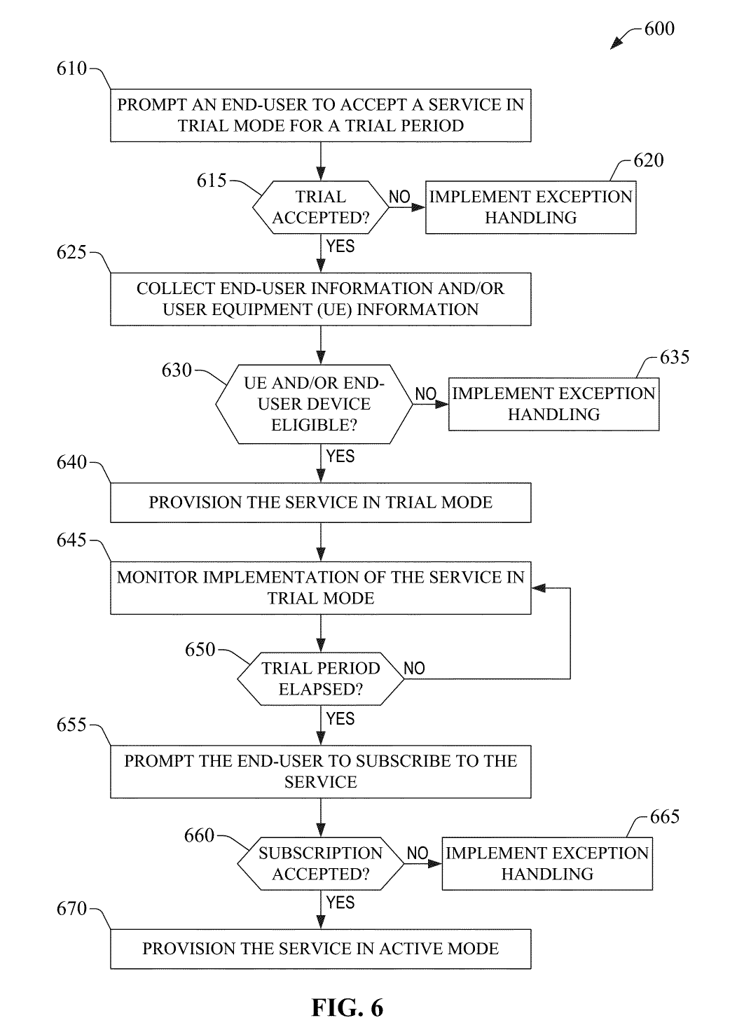

FIG. 5 illustrates a block diagram of an example of a computing environment 500 for configuration of a trial service in accordance with one or more aspects of the disclosure. The example computing environment is merely illustrative and is not intended to suggest or otherwise convey any limitation as to the scope of use or functionality of the computing environment's architecture. In addition, the example computing environment 500 depicted in FIG. 5 should not be interpreted as having any dependency or requirement relating to any one or combination of components illustrated as part of the computing environment 500. The computing environment 500 comprises a computing device 510 which, in various embodiments, can correspond to the computing device 510.

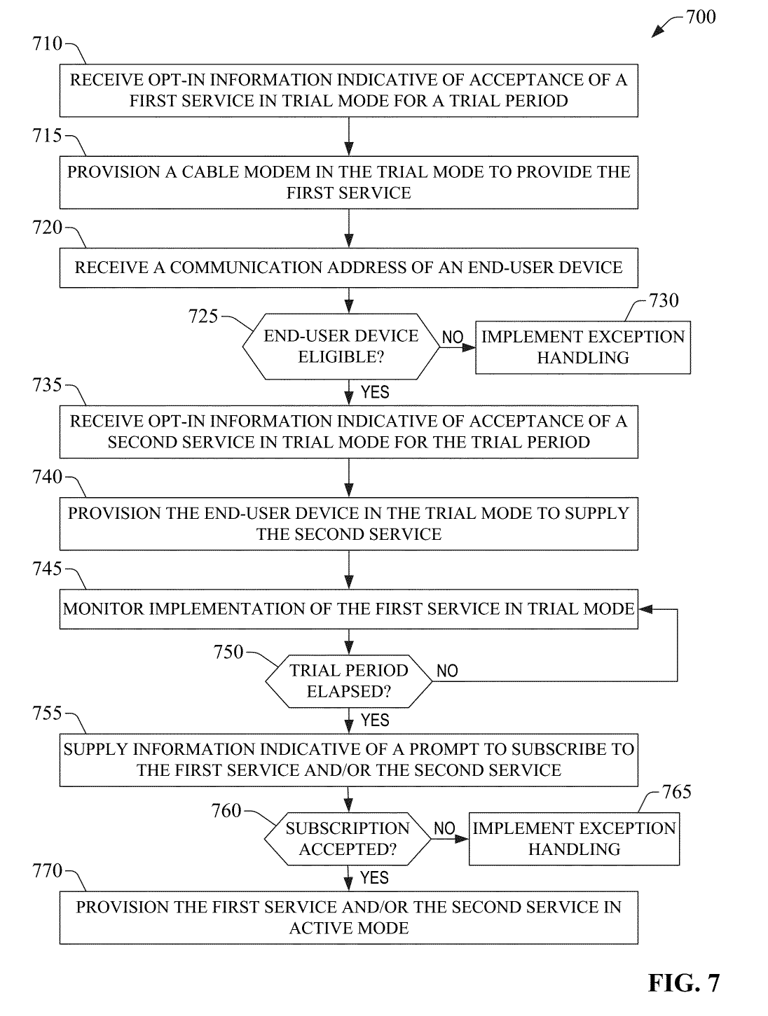

The computing environment 500 represents an example implementation of various aspects of the disclosure in which the processing or execution of operations described in connection with configuration of a trial service as disclosed herein can be performed in response to execution of one or more software components at the computing device 510. It should be appreciated that the one or more software components can render the computing device 510, or any other computing device that contains such components, a particular machine for configuration of a trial service as described herein, among other functional purposes. A software component can be embodied in or can comprise one or more computer-accessible instructions, e.g., computer-readable and/or computer-executable instructions. In one scenario, at least a portion of the computer-accessible instructions can embody and/or can be executed to perform at least a part of one or more of the example methods described herein, such as the example method presented in FIG. 6. For instance, to embody one such method, at least a portion of the computer-accessible instructions can be persisted (e.g., stored, made available, or stored and made available) in a computer storage non-transitory medium and executed by a processor. The one or more computer-accessible instructions that embody a software component can be assembled into one or more program modules that can be compiled, linked, and/or executed at the computing device 510 or other computing devices. Generally, such program modules comprise computer code, routines, programs, objects, components, information structures (e.g., data structures and/or metadata structures), etc., that can perform particular tasks (e.g., one or more operations) in response to execution by one or more processors, which can be integrated into the computing device 510 or functionally coupled thereto.

The various example embodiments of the disclosure can be operational with numerous other general purpose or special purpose computing system environments or configurations. Examples of well-known computing systems, environments, and/or configurations that can be suitable for implementation of various aspects of the disclosure in connection with the configuration of a trial service as described herein can comprise personal computers; server computers; laptop devices; handheld computing devices, such as mobile tablets; wearable computing devices; and multiprocessor systems. Additional examples can include set-top boxes, programmable consumer electronics, network PCs, minicomputers, mainframe computers, blade computers, programmable logic controllers (PLCs), distributed computing environments that comprise any of the above systems or devices, or the like.

As illustrated, the computing device 510 can comprise one or more processors 514, one or more input/output (I/O) interfaces 516, one or more memory devices 530 (herein referred to generically as memory 530), and a bus architecture 532 (also termed bus 532) that functionally couples various functional elements of the computing device 510. In certain embodiments, the computing device 510 can include, optionally, a radio unit (not depicted in FIG. 5). The radio unit can include one or more antennas and a communication processing unit that can permit wireless communication between the computing device 510 and another device, such as one of the computing device(s) 570. At least one of the computing device(s) 570 can have similar or identical architecture to the computing device 510. The bus 532 can include at least one of a system bus, a memory bus, an address bus, or a message bus, and can permit exchange of information (data, metadata, and/or signaling) between the processor(s) 514, the I/O interface(s) 516, and/or the memory 530, or respective functional elements therein. In certain scenarios, the bus 532 in conjunction with one or more internal programming interfaces 550 (also referred to as interface(s) 550) can permit such exchange of information. In scenarios in which the processor(s) 514 include multiple processors, the computing device 510 can utilize parallel computing.

The I/O interface(s) 516 can permit communication of information between the computing device and an external device, such as another computing device, e.g., a network element or an end-user device. Such communication can include direct communication or indirect communication, such as exchange of information between the computing device 510 and the external device via a network or elements thereof. As illustrated, the I/O interface(s) 516 can comprise one or more of network adapter(s) 518, peripheral adapter(s) 522, and rendering unit(s) 526. Such adapter(s) can permit or facilitate connectivity between the external device and one or more of the processor(s) 514 or the memory 530. For example, the peripheral adapter(s) 522 can include a group of ports, which can comprise at least one of parallel ports, serial ports, Ethernet ports, V.35 ports, or X.21 ports, wherein parallel ports can comprise General Purpose Interface Bus (GPIB), and IEEE-1284, while serial ports can include Recommended Standard (RS)-232, V.11, Universal Serial Bus (USB), FireWire or IEEE-1394.

In one aspect, at least one of the network adapter(s) 518 can functionally couple the computing device 510 to one or more computing devices 570 via one or more traffic and signaling pipes 560 that can permit or facilitate exchange of traffic 562 and signaling 564 between the computing device 510 and the one or more computing devices 570. Such network coupling provided at least in part by the at least one of the network adapter(s) 518 can be implemented in a wired environment, a wireless environment, or a combination of both. The information that is communicated by the at least one of the network adapter(s) 518 can result from implementation of one or more operations in a method of the disclosure. Such output can include any form of visual representation, including, but not limited to, textual, graphical, animation, audio, tactile, or the like. In certain scenarios, each of the computing device(s) 570 can have substantially the same architecture as the computing device 510. In addition, or in the alternative, the rendering unit(s) 526 can include functional elements (e.g., lights, such as light-emitting diodes; a display, such as liquid crystal display (LCD), a plasma monitor, a light emitting diode (LED) monitor, an electrochromic monitor; combinations thereof; or the like) that can permit control of the operation of the computing device 510, or can permit conveying or revealing the operational conditions of the computing device 510.

In one aspect, the bus 532 represents one or more of several possible types of bus structures, including a memory bus or memory controller, a peripheral bus, an accelerated graphics port, and a processor or local bus using any of a variety of bus architectures. As an illustration, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, a Peripheral Component Interconnect (PCI) bus, a PCI-Express bus, a Personal Computer Memory Card Industry Association (PCMCIA) bus, a Universal Serial Bus (USB), and the like. The bus 532, and all buses described herein can be implemented over a wired or wireless network connection and each of the subsystems, including the processor(s) 514, the memory 530 and memory elements therein, and the I/O interface(s) 516 can be contained within one or more remote computing devices 570 at physically separate locations, connected through buses of this form, thereby effectively implementing a fully distributed system.

The computing device 510 can comprise a variety of computer-readable media. Computer-readable media can be any available media (transitory and non-transitory) that can be accessed by a computing device. In one aspect, computer-readable media can comprise computer non-transitory storage media (or computer-readable non-transitory storage media) and communications media. Example computer-readable non-transitory storage media can be any available media that can be accessed by the computing device 510, and can comprise, for example, both volatile and non-volatile media, and removable and/or non-removable media. In one aspect, the memory 530 can comprise computer-readable media in the form of volatile memory, such as random access memory (RAM), and/or non-volatile memory, such as read-only memory (ROM).

The memory 530 can comprise functionality instructions storage 534 and functionality information storage 538. The functionality instructions storage 534 can comprise computer-accessible instructions that, in response to execution by at least one of the processor(s) 514, can implement one or more of the functionalities of the disclosure. The computer-accessible instructions can embody or can comprise one or more software components illustrated as service configuration component(s) 536. In one scenario, execution of at least one component of the service configuration component(s) 536 can implement one or more of the methods described herein, such as the example method 600. For instance, such execution can cause a processor that executes the at least one component to carry out a disclosed example method. It should be appreciated that, in one aspect, a processor of the processor(s) 514 that executes at least one of the service configuration component(s) 536 can retrieve information from or retain information in a memory element 540 (referred to as service configuration information 540) in the functionality information storage 538 in order to operate in accordance with the functionality programmed or otherwise configured by the service configuration component(s) 536. Such information can include at least one of code instructions, information structures, or the like. Such instructions and information structures can embody or can constitute machine-learning techniques (e.g., pattern recognition algorithms, inference algorithms, and the like) that can be utilized to implement at least certain functionality described herein. At least one of the one or more interfaces 550 (e.g., application programming interface(s)) can permit or facilitate communication of information between two or more components within the functionality instructions storage 534. The information that is communicated by the at least one interface can result from implementation of one or more operations in a method of the disclosure. In certain embodiments, one or more of the functionality instructions storage 534 and the functionality information storage 538 can be embodied in or can comprise removable/non-removable, and/or volatile/non-volatile computer storage media.

At least a portion of at least one of the service configuration component(s) 536 or the service configuration information 540 can program or otherwise configure one or more of the processors 514 to operate at least in accordance with the functionality described herein. In one embodiment, the service configuration component(s) 536 contained in the functionality instruction(s) storage 534 can include one or more components that can provide the functionality described herein in connection with the configuration of a trial service. One or more of the processor(s) 514 can execute at least one of the service configuration component(s) 536 and leverage at least a portion of the information in the functionality information storage 538 in order to provide the configuration of a trial service in accordance with one or more aspects described herein. As such, it should be appreciated that in certain embodiments, a combination of the processor(s) 514, the service configuration component(s) 536, and the service configuration information 540 can form means for providing various functionalities of the trial service configuration in accordance with one or more aspects of the disclosure. In addition or in other embodiments, as an illustration, at least one processor of the processor(s) 514 can be configured to execute at least a portion of the service configuration component(s) 536 and, in response, the at least one processor can be further configured to receive opt-in information indicative of acceptance of a first service in trial mode for a trial period; to provision a cable modem in the trial mode to supply the first service; to receive a communication address of an end-user device; to receive opt-in information indicative of acceptance of a second service in trial mode for the trial period; and to provision the end-user device in the trial mode to supply the second service for the trial period. In one implementation, in response to execution of at least a portion of the service configuration component(s) 536, the at least one processor can be further configured to cause a remote computing device to configure the cable modem in a provisioned state. The remote computing device can be one of the computing device(s) 570 and, in certain embodiments, can embody or can include the DOCSIS provisioning platform 160. In addition or in other implementations, in response to execution of at least a portion of the service configuration component(s) 536, the at least one processor can be further configured to query another remote computing device for communication address(es) prior to reception of the communication address of the end-user device. For example, such a remote computing device can include one of the computing device(s) 570 and can embody or can include the ACS 150.

In certain embodiments, in response to execution of at least a portion of the service configuration component(s) 536, the at least one processor can be further configured to determine that the trial period elapsed, and to supply information indicative of a prompt to subscribe to the first service. In addition or in yet other embodiments, in response to execution of at least a portion of the service configuration component(s) 536, the at least one processor can be further configured to receive, in response to the prompt, second opt-in information indicative of subscription to the service, and to provision a service account for the service in active mode. Further or in still other embodiments, in response to execution of at least a portion of the service configuration component(s) 536, the at least one processor can be further configured to monitor implementation of the first service.

It should be appreciated that, in certain scenarios, the functionality instruction(s) storage 534 can embody or can comprise a computer-readable non-transitory storage medium having computer-accessible instructions that, in response to execution, cause at least one processor (e.g., one or more of the processor(s) 514) to perform a group of operations comprising the operations or blocks described in connection with the disclosed methods.

In addition, the memory 530 can comprise computer-accessible instructions and information (e.g., data and/or metadata) that permit or facilitate the operation and/or administration (e.g., upgrades, software installation, any other configuration, or the like) of the computing device 510. Accordingly, as illustrated, the memory 530 can comprise a memory element 542 (labeled operating system (OS) instruction(s) 542) that can contain one or more program modules that embody or include one or more operating systems, such as a Windows operating system, Unix, Linux, Symbian, Android, Chromium, or substantially any OS suitable for mobile computing devices or tethered computing devices. In one aspect, the operational and/or architectural complexity of the computing device 510 can dictate a suitable OS. The memory 530 also comprises a system information storage 546 having data and/or metadata that permits or facilitates the operation and/or administration of the computing device 510. Elements of the OS instruction(s) 542 and the system information storage 546 can be accessible or can be operated on by at least one of the processor(s) 514.

It should be recognized that while the functionality instructions storage 534 and other executable program components, such as the OS instruction(s) 542, are illustrated herein as discrete blocks, such software components can reside at various times in different memory components of the computing device 510, and can be executed by at least one of the processor(s) 514. In certain scenarios, an implementation of the service configuration component(s) 536 can be retained on or transmitted across some form of computer-readable media.

The computing device 510 and/or one of the computing device(s) 570 can include a power supply (not shown), which can power up components or functional elements within such devices. The power supply can be a rechargeable power supply, e.g., a rechargeable battery, and it can include one or more transformers to achieve a power level to operate the computing device 510 and/or one of the computing device(s) 570, and components, functional elements, and related circuitry therein. In certain scenarios, the power supply can be attached to a conventional power grid to recharge and ensure that such devices can be operational. In one aspect, the power supply can include an I/O interface (e.g., one of the network adapter(s) 518) to connect operationally to the conventional power grid. In another aspect, the power supply can include an energy conversion component, such as a solar panel, to provide additional or alternative power resources or autonomy for the computing device 510 and/or at least one of the computing device(s) 570.

The computing device 510 can operate in a networked environment by utilizing connections to one or more remote computing devices 570. As an illustration, a remote computing device can be a personal computer, a portable computer, a server, a router, a network computer, a peer device or other common network node, and so on. As described herein, connections (physical and/or logical) between the computing device 510 and a computing device of the one or more remote computing devices 570 can be made via one or more traffic and signaling pipes 560, which can comprise wireline link(s) and/or wireless link(s) and several network elements (such as routers or switches, concentrators, servers, and the like) that form a local area network (LAN) and/or a wide area network (WAN). Such networking environments are conventional and commonplace in dwellings, offices, enterprise-wide computer networks, intranets, local area networks, and wide area networks.

In one or more embodiments, one or more of the disclosed methods can be practiced in distributed computing environments, such as grid-based environments, where tasks can be performed by remote processing devices (computing device(s) 570) that are functionally coupled (e.g., communicatively linked or otherwise coupled) through a network having traffic and signaling pipes and related network elements. In a distributed computing environment, in one aspect, one or more software components (such as program modules) can be located in both the computing device 510 and at least one remote computing device of the computing device(s) 570, for example. It should be appreciated that in such distributed environments, the functionality for configuration of a trial service can be implemented by the system constituted at least by the computing device 510 and at least one of the computing device(s) 570. Such a system can embody or can constitute at least a portion of the example operational environment 100. More specifically, but not exclusively, in one example scenario, the computing device 510 can embody the service configuration platform 130 and the group of computing devices 570 can embody the service provisioning platform 140, the ACS 150, the DOCSIS provisioning platform 160, the BSS/OSS 180, the account management platform 170, and the service platform(s) 485.

In view of the aspects described herein, example methods that can be implemented in accordance with the disclosure can be better appreciated with reference to the diagram in FIG. 6. For purposes of simplicity of explanation, the example methods disclosed herein are presented and described as a series of blocks. However, it is to be understood and appreciated that the disclosed methods are not limited by the order of blocks and associated actions, as some blocks may occur in different orders and/or concurrently with other blocks from that shown and described herein. For example, the various methods or processes of the disclosure can be alternatively represented as a series of interrelated states or events, such as in a state diagram. Furthermore, not all illustrated blocks and associated action(s) may be required to implement a method in accordance with one or more aspects of the disclosure. Further yet, two or more of the disclosed methods or processes can be implemented in combination with each other, to accomplish one or more features or advantages described herein. At least a portion of the methods described herein can be implemented (e.g., configured (such as linked, compiled, a combination thereof, or the like); executed; configured and executed; or the like) by a system having at least one processor and at least one information storage devices (which also may be referred to as at least one memory device or at least one memory). Such a system can comprise one or more computing devices or one or more processors, and can be employed to execute computer-accessible instructions retained in a memory, or any computer-readable or machine-readable medium, to implement the methods described herein. The computer-accessible instructions can provide a computer-executable or machine-executable framework to implement the methods described herein.

It should be further appreciated that the example methods of the disclosure can be retained on an article of manufacture, or computer-readable medium, to permit or otherwise facilitate transporting and transferring such methods to a computing device (e.g., a desktop computer, a mobile computer, such as a tablet or a smarphone; a mobile telephone, a blade computer, a programmable logic controller, and the like) for execution, and thus implementation, by a processor of the computing device or for storage in a memory thereof.

FIG. 6 presents a flowchart of an example method 600 for configuring a trial service in accordance with one or more embodiments of the disclosure. In one embodiment, a system that has at least one processor can implement (e.g., configure, compile, link, execute, combinations thereof, or the like) one or more blocks of the subject example method. The at least one processor can be functionally coupled to at least one memory device having encoded thereon computer-accessible instructions that represent the subject example method and, in response to execution by the system or the at least one processor, permit or otherwise facilitate implementation of the subject example method in part or in its entirety. In additional or alternative embodiments, a computing device that has at least one processor or is functionally coupled thereto can implement one or more blocks of the subject example method. The at least one processor can be functionally coupled to at least one memory device having encoded thereon computer-accessible instructions that represent the subject example method and, in response to execution by the system or the at least one processor, permit or otherwise facilitate implementation of the subject example method.

At block 610, an end-user can be prompted to accept a service in trial mode for a trial period (e.g., seven days, 10 days, 14 days, 30 days, or the like). At block 615, it is determined if the service is accepted in trial mode. For instance, as described herein, the service configuration platform 130, via the trial monitor 218, can receive opt-in information indicative of acceptance of the service in trial mode. The opt-in information can be received via one of a group of interfaces 212 of the service configuration platform 130. Therefore, the service configuration platform 130 can determine that the service is accepted in trial mode. In response to a determination that the service is not accepted in trial mode, exception handling can be implemented at block 620. In contrast, in response to a determination that the service is accepted in trial mode, end-user information and/or user-equipment information can be collected at block 625. As an illustration, the end-user information can include apartment community name, apartment number, tenant names, and the like, and the user-equipment information can include a MAC address or another type of communication address. At block 630, it can be determined if the UE and/or the end-user is eligible for accessing the service in trial mode. In one example, the service configuration platform 130, via the trial monitor 218, for example, can determine such eligibility. In response to a determination that the UE and the end-user, individually or in combination, fail to be eligible, exception handling can be implemented at block 635. In contrast, in response to a determination that the UE and the end-user are eligible, the service can be provisioned in trial mode at block 640. To that end, in one example, at least one of the provisioning units 220 can direct or otherwise cause the DOCSIS provisioning platform 160 and/or the service provisioning platform 140 to provision the service in trial mode. In addition, at block 645, implementation of the service in trial mode can be monitored. For instance, the trial monitor 218 in combination with the communication-address state monitor 224 can monitor implementation of the service in trial mode. More specifically, in one example, the trial monitor 218 can determine if the trial period has elapsed and the communication-address state monitor 224 can determine if the MAC address (or another type of communication address, such as IP address) of a CPE or UE is in a trial state. For a trial period that has not elapsed and for a communication address in the trial state, the service can be provided. As described herein, a service platform (e.g., a Wi-Fi connectivity platform, a media-on-demand platform, a platform for TV service on a second-screen, or the like) can provide the service.

At block 650, it can be determined if the trial period for consuming a service in trial mode has elapsed. In response to a determination that the trial period has not elapsed, the flow be directed to block 645. In the alternative, in response to a determination that the trial period has elapsed, at block 655, the end-user that consumes the service can be prompted to subscribe to the service. For example, the trial monitor 218 can switch the state of the CPE 120 to a captive state, and the portal unit 216 can supply prompt information that can be presented, upon or after suitable processing, for example, at a UE (e.g., UE 110a or UE 110b). At block 660, it can be determined if a subscription to the service is accepted. In one example, the service configuration platform 130 can receive, via one of the interfaces 212, for example, opt-in information indicative of a subscription to the service and/or a selection of another service and a subscription thereof. Therefore, the service configuration platform 130 can determine that the subscription to the service or another type of subscription has been accepted. In response to a determination that the subscription is not accepted, exception handling can be implemented at block 665. More specifically, the service configuration platform 130 can configure, via one of the provisioning unit(s) 220, for example, the CPE 120 or other equipment in a non-provisioned or captive state. In response to a determination that the subscription to the service is accepted, the service can be provisioned in active mode at block 670. To that end, in one example, the service configuration platform 130 can provision, via at least one of the provisioning unit(s) 220, for example, a new service account and/or entitlements for authentication and authorization to the subscribed service(s).

FIG. 7 presents a flowchart of another example method 700 for configuring a trial service in accordance with one or more embodiments of the disclosure. In one embodiment, a system that has at least one processor can implement (e.g., configure, compile, link, execute, combinations thereof, or the like) one or more blocks of the subject example method. The at least one processor can be functionally coupled to at least one memory device having encoded thereon computer-accessible instructions that represent the subject example method and, in response to execution by the system or the at least one processor, permit or otherwise facilitate implementation of the subject example method in part or in its entirety. In additional or alternative embodiments, a computing device that has at least one processor or is functionally coupled thereto can implement one or more blocks of the subject example method. The at least one processor can be functionally coupled to at least one memory device having encoded thereon computer-accessible instructions that represent the subject example method and, in response to execution by the system or the at least one processor, permit or otherwise facilitate implementation of the subject example method.

At block 710, opt-in information can be received, where the opt-in information can be indicative or otherwise representative of acceptance of a first service in trial mode. As an example, the first trial service can include broadband service. In one embodiment, as described herein, the service configuration platform 130, via at least one of the interface(s) 212, can receive a portion of such opt-in information. The received opt-in information can be sent or otherwise transmitted to the trial monitor 218 within the service configuration platform 130. In one aspect, using the received information, the trial monitor 218 can establish or otherwise determine that the first service in trial mode has been accepted. In certain implementations, as described herein, at least a portion of the opt-in information can be received in response to providing a prompt (or prompting) an end-user to accept the first service (see, e.g., block 610).

At block 715, a cable modem can be provisioned in the trial mode in order to supply or otherwise provide the first service. As described herein, in certain embodiments, a provisioning unit of the provisioning unit(s) 220 can provision the cable modem in the trial mode to provide the first service. In addition or in other embodiments, provisioning the cable modem in the trial mode can include causing a remote computing device (e.g., the DOCSIS provisioning platform 160) to configure the cable modem in a provisioned state. The service configuration platform 130 can cause the remote computing device to configure the cable modem in such a state. At block 720, a communication address of an end-user device (e.g., a mobile computing device) can be received. The communication address can be embodied in or can include, for example, an IP address, a MAC address, or another type of address that permits communication of information between the end-user device and another computing device. In certain embodiments, at least one of the interface(s) 212 can receive the communication address. In addition or in other embodiments, the communication address can be received in response to a query from the service configuration platform 130, via the trial monitor 218, to a remote computing device (e.g., the ACS 250) that can provide (e.g., detect or otherwise collect and supply) the communication address. More generally, the service configuration platform 130 can direct or otherwise cause the remote computing device to provide the communication address.

At block 725, it is determined if the end-user device is eligible to be provisioned for service. The service configuration platform 130 can perform such a determination and, in response to ascertaining that the end-user device is not eligible, exception handling can be implemented at block 730. In the alternative, in response to ascertaining that the user-device is eligible, opt-in information indicative or otherwise representative of acceptance of a second service in trial mode can be received at block 735. For instance, the service configuration platform 130, via one or more of the interface(s) 212, can receive at least a portion of such opt-in information. The service can be embodied in or can include, for example, pay-per-view selections or options; end-user customized selection of channels or media assets (e.g., video-on-demand assets or time-shifted assets); a media-on-demand service (music-on-demand, video-on-demand, or the like); a second-screen service (e.g., television service provided via a tablet computer); combinations thereof; or the like. At block 740, the end-user device can be provisioned in the trial mode in order to supply the second service. As described herein, in certain embodiments, a provisioning unit of the provisioning unit(s) 220 can provision the end-user device in the trial mode in order to provide the second service.

At block 745, implementation of the first service (e.g., broadband service) can be monitored. It should be appreciated that, in certain embodiments, the second service (e.g., media on a second-screen device) also can be monitored. As described herein, in one example, the service configuration platform 130, via the trial monitor 218, can monitor the implementation of the first service and/or the second service. Monitoring the first service and/or the second service can include monitoring for abuse of the service or for other types of unintended user of the first and/or second service.

At block 750, it is determined if the trial period has elapsed. In certain embodiments, the service configuration platform 130, via the trial monitor 218, can determine if the trial period has elapsed. It should be appreciated that, in certain embodiments, determining if the trial period has elapsed can be part of monitoring the implementation of the first service at block 745. In response to ascertaining that the trial period (e.g., seven days, 14 days, 30 days, etc.) has not elapsed, flow can be directed to block 745. In the alternative, in response to ascertaining that the trial period has elapsed, information indicative or otherwise representative of a prompt to subscribe to the first service and/or the second service can be supplied (e.g., generated and transmitted) at block 755. At block 760, it can be determined if the prompt to subscribe to the first service and/or second service has been accepted. As described herein, in certain embodiments, the trial monitor 218 can switch the state of the CPE 120 to a captive state, and the portal unit 216 can supply prompt information that can be presented, upon or after suitable processing, for example, at a UE (e.g., UE 110a or UE 110b). In addition or in other embodiments, the service configuration platform 130 can receive, via one of the interfaces 212, for example, opt-in information indicative of a subscription to the first service and/or the second service. As such, the service configuration platform 130 can determine that the subscription to the first service and/or the second service has been accepted.

In response to a determination that subscription to the first service and/or the second service is not accepted, exception handling can be implemented at block 765. More specifically, the service configuration platform 130 can configure, via one of the provisioning unit(s) 220, for example, the CPE 120 or other equipment in a non-provisioned or captive state. In the alternative, in response to a determination that the subscription to the first service and/or the second service is accepted, the subscribed service(s) can be provisioned in active mode at block 770. To that end, in one example, the service configuration platform 130 can provision, via at least one of the provisioning unit(s) 220, for example, a new service account and/or entitlements for authentication and authorization to the subscribed service(s).

It should be appreciated that, in certain embodiments, the example method 700 can be implemented in conjunction or in addition to the example method 600. In other embodiments, the example method 700 can embody or can constitute at least some portions of the example method 600.

Disclosed are functional elements, such as components, units, engines, interfaces, platforms, repositories, etc., that can be utilized to perform the disclosed methods and systems. These and other functional elements are disclosed herein, and it is understood that when combinations, subsets, interactions, groups, etc. of these components are disclosed, while specific reference to each of various individual and collective combinations and permutations of these may not be explicitly disclosed, each is specifically contemplated and described herein, for all methods and systems. This applies to all aspects of this disclosure including, but not limited to, steps in the disclosed methods. Thus, if there are a variety of additional steps that can be performed, it is understood that each of these additional steps can be performed with any specific embodiment or combination of embodiments of the disclosed methods.

The methods, systems, solutions, and the like, of the disclosure may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Functionality of the embodiments of the disclosure is described herein with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that, in certain embodiments, each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Various embodiments of the disclosure may take the form of an entirely or partially hardware embodiment, an entirely or partially software embodiment, or a combination of software and hardware (e.g., a firmware embodiment). Furthermore, as described herein, various embodiments of the disclosure (e.g., methods and systems) may take the form of a computer program product comprising a computer-readable non-transitory storage medium having machine-accessible instructions (e.g., computer-readable and/or computer-executable instructions) such as computer software, encoded or otherwise embodied in such storage medium. Those instructions can be read or otherwise accessed and executed by one or more processors to perform or permit performance of the operations described herein. The instructions can be provided in any suitable form, such as source code, compiled code, interpreted code, executable code, static code, dynamic code, assembler code, combinations of the foregoing, and the like. Any suitable computer-readable non-transitory storage medium may be utilized to form the computer program product. For instance, the computer-readable medium may include any tangible non-transitory medium for storing information in a form readable or otherwise accessible by one or more computers or processor(s) functionally coupled thereto. Non-transitory storage media can include read-only memory (ROM); random access memory (RAM); magnetic disk storage media; optical storage media; flash memory, etc.

At least some embodiments of the techniques in accordance with the disclosure are described with reference to block diagrams and flowchart illustrations of methods, computing devices, apparatuses and/or computer program products. It can be understood that each block of the block diagrams and flowchart illustrations, and combinations of blocks in the block diagrams and flowchart illustrations, respectively, can be implemented by machine-accessible instructions. In certain implementations (such as in the example computing environment described in connection with FIG. 5) the machine-accessible instructions may be loaded or otherwise incorporated into a general purpose computer, special purpose computer, or other programmable information processing apparatus to produce a particular machine, such that at least some or all of the operations or functions specified in the flowchart block or blocks can be implemented in response to execution at the computer or processing apparatus.

As employed in this specification, annexed drawings, and/or claims the terms “unit,” “component,” “engine,” “system,” “platform,” “environment,” “interface,” “repository,” “portal,” and the like are intended to include a computer-related entity or an entity related to an operational apparatus with one or more functionalities afforded by one or more computational resources, such as processor(s), one or more memories, network connector(s), combination thereof, and the like. The computer-related entity or the entity related to the operational apparatus can be either hardware, a combination of hardware and software, software, or software in execution. One or more of such entities also may be referred to as “functional elements.” As an example, a unit may be, but is not limited to being, a process running on a processor, a processor, an object, an executable computer program, a thread of execution, a program, a memory (e.g., a hard disc drive), and/or a computer. As another example, a unit can be an apparatus with specific functionality provided by mechanical parts operated by electric or electronic circuitry which is operated by a software or a firmware application executed by a processor, wherein the processor can be internal or external to the apparatus and executes at least a part of the software or firmware application. As yet another example, a unit can be an apparatus that provides specific functionality through electronic functional elements without mechanical parts, the electronic functional elements can include a processor therein to execute software or firmware that provides at least in part the functionality of the electronic functional elements. An illustration of such apparatus can be control circuitry, such as a programmable logic controller. The foregoing examples and related illustrations are but a few examples and are not intended to limiting or otherwise restrictive. Moreover, while such illustrations are presented for a unit, the foregoing examples also apply to a component, a system, a platform, an interface and the like. It is noted that in certain embodiments, or in connection with certain aspects or features thereof, the terms “unit,” “component,” “engine,” “system,” “platform,” “environment,” “interface,” “repository,” and “portal” can be utilized interchangeably.

Throughout the present specification and drawings of the disclosure, the words “comprise,” “include,” and “have” and variations of such words, such as “comprising” and “comprises,” “including” and “includes,” “having” and “has,” mean “including but not limited to,” and are not intended to exclude, for example, other systems, subsystems, components, action, steps, or the like. When utilized, the term “exemplary” refers to “an example of” and is not intended to convey an indication of a preferred or ideal embodiment, entity, feature, or the like. “Such as” is not utilized in the present disclosure in a restrictive sense, but rather it is put forward for explanatory purposes.

As it is employed in the subject disclosure, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

In the subject specification and annexed drawings, terms such as “store,” “data store,” “data storage,” “database,” “repository,” and substantially any other information storage component relevant to the operation and functionality of a component, refer to “memory components,” or entities embodied in a “memory” or components comprising the memory. It will be appreciated that the memory components described herein can be either volatile memory or nonvolatile memory, or can include both volatile and nonvolatile memory. In addition, memory elements described herein can be affixed, removable, or a combination thereof.

By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as an external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Unless otherwise expressly stated, it is in no way intended that any technique, protocol, procedure, process, or method set forth herein be construed as requiring that its acts or steps be performed in a specific order. Accordingly, where a process or method claim does not actually recite an order to be followed by its acts or steps or it is not otherwise specifically recited in the claims or descriptions of the subject disclosure that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification or annexed drawings; or the like.

What has been described herein in the present specification and annexed drawings includes examples of systems, devices, and techniques that permit configuring a service from a multi-service operator to customer premises equipment and user equipment. It is, of course, not possible to describe every conceivable combination of components and/or methodologies for purposes of describing the various features of the disclosure, but one of ordinary skill in the art can recognize that many further combinations and permutations of the claimed subject matter are possible. Accordingly, it may be apparent that various modifications and/or variations can be made to the disclosure without departing from the scope or spirit thereof. In addition or in the alternative, other embodiments of the disclosure may be apparent from consideration of the specification and annexed drawings, and practice of the disclosure as presented herein. It is intended that the examples put forward in the specification and annexed drawings be considered, in all respects, as illustrative and not restrictive.

What is claimed is:

1. A method for configuring services from a multiple services operator, comprising:
receiving, by a computing platform comprising at least one memory device and at least one processor, opt-in information indicative of acceptance of a first service in trial mode for a trial period;
provisioning, by the computing platform, a cable modem in the trial mode to supply the first service;
receiving, by the computing platform, a communication address of an end-user device;
receiving, by the computing platform, opt-in information indicative of acceptance of a second service in trial mode for the trial period; and
provisioning, by the computing platform, the end-user device in the trial mode to supply the second service for the trial period.

2. The method of claim 1, further comprising determining, by the computing platform, that the trial period elapsed, and
supplying information indicative of a prompt to subscribe to the first service.

3. The method of claim 2, further comprising receiving, by the computing platform, in response to the prompt, second opt-in information indicative of subscription to the service, and
provisioning, by the computing platform, a service account for the service in active mode.

4. The method of claim 1, further comprising monitoring, by the computing platform, implementation of the first service.

5. The method of claim 1, wherein provisioning the cable modem in the trial mode comprises causing a remote computing device to configure the cable modem in a provisioned state.

6. The method of claim 1, further comprising querying, by the computing system, a remote computing device for communication addresses prior to receiving the communication address of the end-user device.

7. An apparatus, comprising:
at least one memory device having instructions stored therein;
at least one processor configured to execute the instructions and, in response, further configured at least to:
receive opt-in information indicative of acceptance of a first service in trial mode for a trial period;
provision a cable modem in the trial mode to supply the first service;
receive a communication address of an end-user device;
receive opt-in information indicative of acceptance of a second service in trial mode for the trial period; and
provision the end-user device in the trial mode to supply the second service for the trial period.

8. The apparatus of claim 7, wherein in response to execution of the instructions the at least one processor is further configured to determine that the trial period elapsed, and
to supply information indicative of a prompt to subscribe to the first service.

9. The apparatus of claim 8, wherein in response to execution of the instructions the at least one processor is further configured to receive, in response to the prompt, second opt-in information indicative of subscription to the service, and
to provision a service account for the service in active mode.

10. The apparatus of claim 7, wherein in response to execution of the instructions the at least one processor is further configured to monitor implementation of the first service.

11. The apparatus of claim 7, wherein in response to execution of the instructions the at least one processor is further configured to cause a remote computing device to configure the cable modem in a provisioned state.

12. The apparatus of claim 7, wherein in response to execution of the instructions the at least one processor is further configured to query a remote computing device for communication addresses prior to reception of the communication address of the end-user device.

13. The apparatus of claim 11, wherein the remote computing device includes a provisioning server that operates according to data over cable service interface specification (DOCSIS).

14. The apparatus of claim 12, wherein the remote computing device includes an ACS that operates operate according to customer premises equipment (CPE) WAN Management Protocol (CWMP) as specified in Technical Report (TR)-069.

15. At least one computer-readable non-transitory storage medium having encoded thereon instructions that, in response to execution, cause a computing platform to perform operations comprising:
receiving opt-in information indicative of acceptance of a first service in trial mode for a trial period;
provisioning a cable modem in the trial mode to supply the first service;
receiving a communication address of an end-user device;
receiving opt-in information indicative of acceptance of a second service in trial mode for the trial period; and
provisioning the end-user device in the trial mode to supply the second service for the trial period.

16. The at least one computer-readable non-transitory storage medium of claim 15, wherein the operations further comprise determining that the trial period elapsed, and
supplying information indicative of a prompt to subscribe to the first service.

17. The at least one computer-readable non-transitory storage medium of claim 16, wherein the operations further comprise receiving, in response to the prompt, second opt-in information indicative of subscription to the service, and
provisioning a service account for the service in active mode.

18. The at least one computer-readable non-transitory storage medium of claim 17, wherein the operations further comprise monitoring implementation of the first service.

19. The at least one computer-readable non-transitory storage medium of claim 17, wherein the operations further comprise causing a remote computing device to configure the cable modem in a provisioned state.

20. The at least one computer-readable non-transitory storage medium of claim 17, wherein the operations further comprise querying a remote computing device for communication addresses prior to reception of the communication address of the end-user device.
